(19) United States
(12) Patent Application Publication
(10) Pub. No.: US 2012/0120816 A1
(43) Pub. Date: May 17, 2012

(54) LOCATION AND NETWORK BASED MOBILE DEVICE POWER MANAGEMENT

(75) Inventor: Dinesh K. Garg, San Diego, CA (US)

(73) Assignee: QUALCOMM INNOVATION CENTER, INC., San Diego, CA (US)

(21) Appl. No.: 12/946,649

(22) Filed: Nov. 15, 2010

(51) Int. Cl. H04L 12/26; H04W 4/00

(52) U.S. Cl. 370/252; 370/328

(57) ABSTRACT

Methods and apparatus for reducing power use in a mobile device are disclosed. In accordance with many embodiments, a method includes receiving network-location information that indicates a coverage area of each of a plurality of available wireless networks and receiving mobile-device-location information that identifies a location of the mobile device. And in addition, in the event the mobile device is within an area that is not covered by any of the plurality of available wireless networks, an attempt to communicate with any of the plurality of wireless networks is delayed based upon the mobile-device-location information indicating the location of the mobile device is not within a coverage area of at least one of the plurality of wireless networks.

### FIELD OF THE INVENTION

The present invention relates to mobile communication devices. In particular, but not by way of limitation, the present invention relates to apparatus and methods for managing power on mobile communication devices.

### BACKGROUND OF THE INVENTION

Mobile communication devices including devices such as smartphones, netbooks, gaming devices, PDAs, and laptop computers are now ubiquitous. A common and ongoing issue with these types of devices is power management. More specifically, these types of devices continue to develop more advanced processing resources, displays, and communication systems that demand more and more power.

In addition to the components on mobile communication devices creating increasing power demands, users' desire to wirelessly communicate (e.g., by voice and/or data) over a wide range of urban and rural geographical areas has also created power demands. And wireless network providers (e.g., carriers and hotspot providers) have responded to this user demand (and created even more demand) by deploying a wide variety of networks that are distributed all over the world. As a consequence of the expansive wireless network coverage that has developed, users now rely upon, and expect, a broad area of wireless network coverage.

Although wireless networks now cover large geographical areas, the coverage of these networks is certainly not universal, and the power demands placed on mobile devices vary depending upon the types of networks that are available. For example, some areas may be simultaneously covered by many types of networks (e.g., 2G, 3G, 4G, WiFi, and Wimax) while other areas have little or no coverage at all. And the sporadic coverage that is encountered by mobile devices often adversely affects the operating power of mobile devices. In short, current mobile device power management techniques are not always able adapt to the particular network environment, and will most certainly not be satisfactory in the future.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

In accordance with several embodiments, the invention may be characterized as a method for managing network communications on a mobile device that includes receiving network-location information that includes information that details a coverage area of each of a plurality of available wireless networks. The method also includes receiving mobile-device-location information that identifies a location of the mobile device, and in the event the mobile device is within an area that is not covered by any of the plurality of available wireless networks, an attempt to communicate with any of the plurality of wireless networks is delayed based upon the mobile-device-location information indicating the location of the mobile device is not within a coverage area of at least one of the plurality of wireless networks.

Another embodiment of the invention may be characterized as a mobile communication device that includes a GPS system that is configured to provide device-location information that identifies a location of the mobile device using GPS signals received from GPS satellites and a data store that is configured to store network-location information that includes information that details a coverage area of each of a plurality of available wireless networks. In addition, a wireless network interface is configured to wirelessly communicate with at least some of the plurality of wireless networks, and a network control system is configured to enable and disable searches for wireless networks based upon the device-location information in connection with the network-location information.

Yet another embodiment of the invention may be characterized as a non-transitory, tangible computer readable storage medium, encoded with processor readable instructions to perform a method for managing power on a mobile device. The method includes receiving network-location information from a network information database that details a coverage area of each of a plurality of available wireless networks and receiving mobile-device-location information at the mobile device while the mobile device is moving across areas that are covered by the plurality of wireless networks and areas that are not covered by the plurality of wireless networks. In addition, the method includes delaying, in the event the mobile device is within an area that is not covered by any of the plurality of available wireless networks, an attempt to communicate with any of the plurality of wireless networks based upon the mobile-device-location information indicating the location of the mobile device is not within a coverage area of at least one of the plurality of wireless networks.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a diagram depicting an exemplary environment in which embodiments of the present invention may be utilized;

FIG. 2 is a block diagram depicting a mobile communication device according to an exemplary embodiment of the present invention;

FIG. 3 is a block diagram depicting physical components that may be used to realize the functional components of the mobile communication devices depicted in FIGS. 1 and 2; and

FIG. 4 is a flowchart that depicts a method that may be carried out in connection with the embodiments described with reference to FIGS. 1-3.

### DETAILED DESCRIPTION

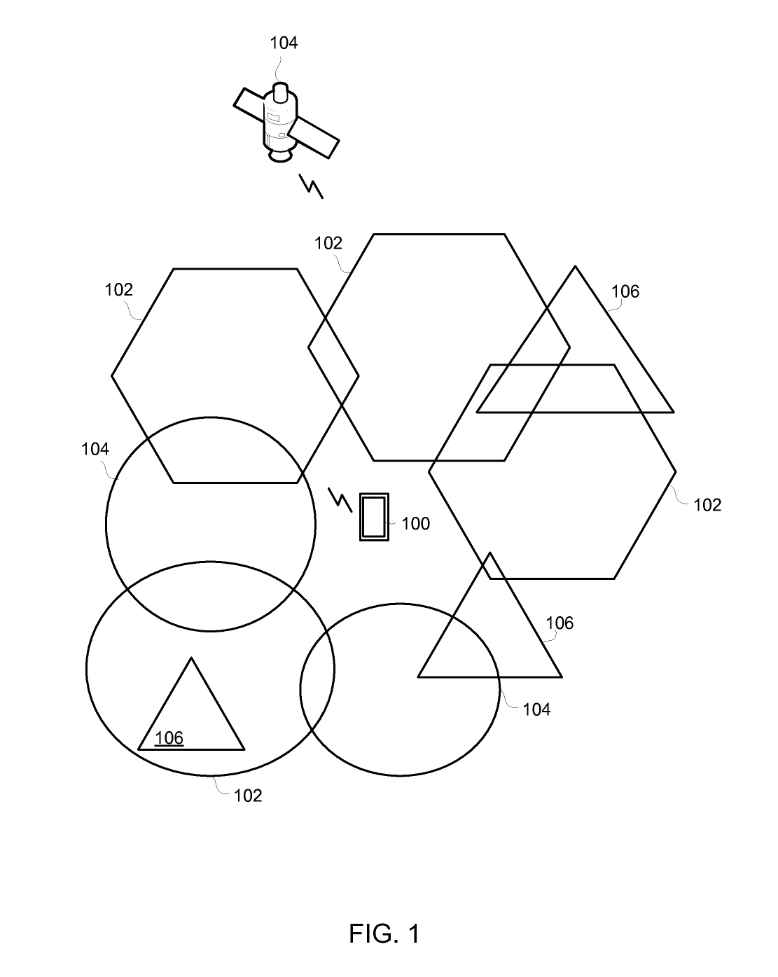

Referring first to FIG. 1, it is a diagram depicting an exemplary environment in which embodiments of the present invention may be utilized. As shown, the depicted environment includes a mobile communication device 100 disposed among several wireless networks including a first type 102, a second type 104, and a third type 106. The depiction of the wireless networks 102, 104, 106 in FIG. 1 is intended to generally represent the reality of overlapping wireless networks that exists in many locations while other locations lack wireless networks altogether. In addition, the mobile communication device in this embodiment is in communication with a global positioning satellite (GPS) 104.

In general, several embodiments of the present invention enable the mobile communication device 100 to operate its wireless communication systems based upon its location among the wireless networks 102, 104, 106 so as to more efficiently utilize power on the mobile device 100. In accordance with many embodiments for example, the mobile device 100 operates its wireless network interface utilizing a data store of network-location information in connection with mobile-device-location information that is received from the GPS satellite 104. More specifically, many implementations of the invention enable the mobile device 100 to selectively enable and disable network interfaces on the mobile device 100 based upon whether the mobile device 100 is in a location that is covered by one or more of the a wireless networks 102, 104, 106.

In this implementation, the GPS satellite 104 communicates with the mobile device 100 independently of the wireless networks 102, 104, 106; thus enabling the mobile device 100 to receive location information and dynamically operate its network interface using the received location information when the mobile device 100 is not within a range of any of the wireless networks 102, 104, 106. Although a GPS satellite 104 is utilized in this and many other embodiments of the invention, it is contemplated that other existing, or yet to be developed, positioning systems that provide position information independent of the wireless networks 102, 104, 106 may be utilized.

The mobile device 100 may be any one of a variety of devices that are mobile and communicate wirelessly. For example, the mobile device 100 may be realized as a smartphone, netbook, gaming device, PDA, or a laptop computer. In many embodiments, the mobile device 100 is capable of communicating with two or more wireless network types including, for example, 3G, 4G, WiFi, and WiMax networks. But this is certainly not required, and in other variations, the mobile device 100 communicates according to only a single wireless communication protocol.

The wireless networks 102, 104, 106 generally provide connectivity to voice and/or data networks. As depicted, the coverage of many of the wireless networks 102, 104, 106 networks overlaps with the coverage of other ones of the networks 102, 104, 106, and the coverage of one or more of the networks may be entirely within the coverage of another network. But as depicted, the coverage of each of the networks 102, 104, 106 is limited in geographical area and there are gaps in coverage where there is no wireless network coverage at all.

The depiction of the wireless networks 102, 104, 106 is not intended to be limited to any particular types of networks, but for exemplary purposes, the first network type 102 may be a 3G cellular network, the second network type 104 may be a 4G cellular network, and the third type 106 may be a Wi-Fi type wireless network. But again, these network types are only exemplary and several embodiments of the present invention provide substantial power savings in the context of an environment in which only a single type of wireless network is present.

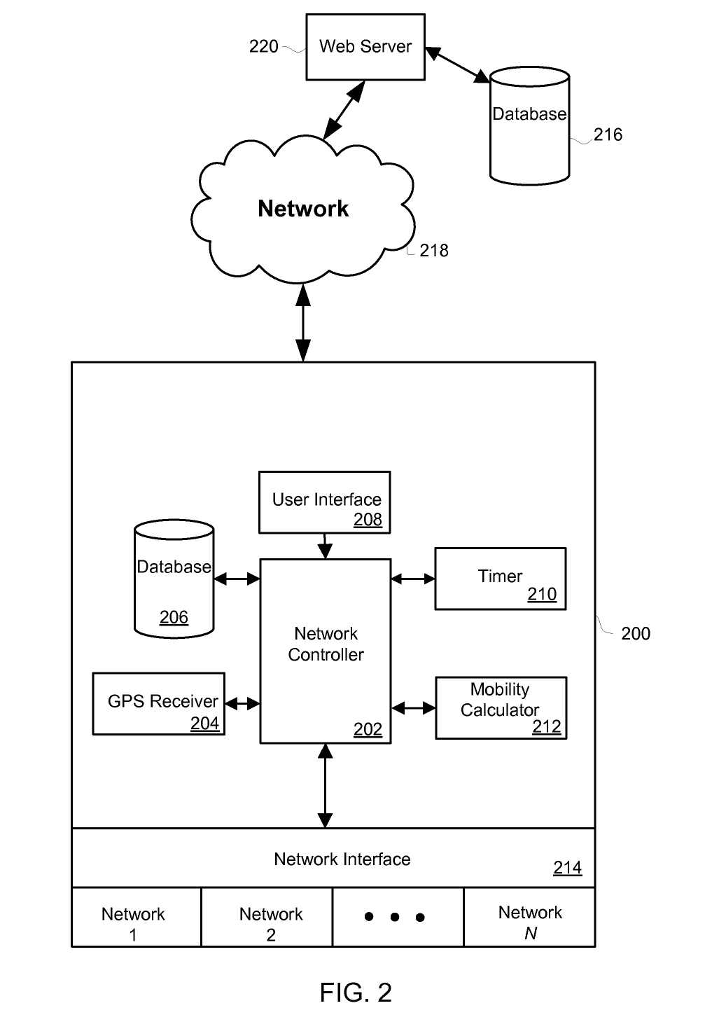

In FIG. 1, the mobile device is depicted outside the coverage of any of the wireless networks 102, 104, 106. When outside of wireless network coverage, typical mobile devices are designed to persistently continue to attempt to self register with any available wireless network. And while these typical mobile devices are searching for an available network (e.g., wireless cell network), they generally transmit power at a maximum power level; thus demanding a high level of battery power and unnecessarily using energy. In contrast, as discussed further herein in connection with FIGS. 2-4, various embodiments of the mobile device 100 dynamically adjust to the relative location of the mobile device 100 to the networks 102, 104, 106 and/or the types of wireless networks that are available to the mobile device 100.

Referring next to FIG. 2, shown is a block diagram depicting the functional components of an exemplary mobile device 200 according to an embodiment of the invention. As shown, the mobile device 200 includes a network controller component 202 that is coupled to a GPS receiver component 204, a database 206, a user interface 208, a timer component 210, a mobility calculator component 212, and a network interface 214. In addition, the network interface 214 includes N communication components for communicating with each of N types of wireless networks. The mobile device 200 is also coupled to a remote database 216 via a network 218 and webserver 220.

The illustrated arrangement of these components is logical, the connections between the various components are exemplary only, and the depiction of this embodiment is not meant to be an actual hardware diagram. And one of ordinary skill in the art will readily appreciate that the depicted components may be realized by a combination of hardware and software, and can be combined, or further separated and sub-divided, in an actual implementation. In addition, the components can be connected in a variety of ways without changing the basic operation of the system. Moreover, components may be removed and/or supplemented so that more or less components can be utilized in any particular implementation.

The network controller 202 generally functions to enable and disable particular ones of the N network components based upon device-location-information (e.g., latitude and longitude of the mobile device 200) received from the GPS receiver 204 and network-location information (e.g., latitude and longitude data for wireless networks) that is retrieved from the database 206. As discussed further herein, the network controller 202 may be designed so as to be capable of controlling the other functional components that are depicted in FIG. 2 in a variety of ways based upon default modes of operation and/or user-configurable modes of operation.

The database 206 is generally configured to store network-location information, which includes data that provides the locations of a plurality of wireless networks. The exemplary mobile device 200 depicted in FIG. 2 includes N network interfaces (where N is equal to one or more) that correspond to N network types. And the database 206 in this embodiment includes information identifying whether one or more of the N network types has coverage in particular geographical locations.

In many implementations, the network controller 202 updates the network-location information in the database 206 with up-to-date network-location information that is received from the remote database 216. Although not required, the network controller 202 in many variations of the depicted embodiment is adapted to enable the network-location information that is stored in the database 206 on the mobile device 200 to be selectively retrieved from the remote database 216 based upon a current location of the mobile device 200 and/or anticipated locations of the mobile device 200. In this way, the amount of data that is stored in the database 206 on the mobile device 200 may be reduced (e.g., to utilize less memory) based upon the locations where the mobile device 200 is more likely to be traveling.

In some implementations, for example, the network controller 202 may be configured to retrieve (while a wireless network is available) network-location information for wireless networks that are within a particular radius of a current location of the mobile device 200. And the radius may be adjusted based upon available memory on the mobile device 200 and/or preferences (e.g., location preferences and memory-utilization preferences) that are entered by the user via the user interface 208, which may be realized by a combination of a keyboard (e.g., touch screen or physical) and graphical display that is presented to the user.

And in addition, the network-location information that is retrieved from the remote database 216 (and stored in the database 206 on the mobile device 200) may be based upon anticipated travel of the user. For example, a history of a user's travel may be maintained so that the network-location information that is stored in the database 206 is related to previous travels of the user. As another example, a user may enter a travel plan in advance of the travel, and the network controller 202 may selectively retrieve network-location information from the remote database 216 (to store in the database 206) that is based upon the entered travel plan. And in some variations, the user may enter the particular mode of travel (e.g., air, bike, train, car, boat, etc.).

In addition to receiving network-location information from the remote database 216, it is also contemplated that the database 206 may be augmented based upon user-entered network information and/or the networks that are experienced by the mobile device. For example, if the mobile device 200 identifies (e.g., while scanning) a hotspot that is not characterized in the network-location information in the database 206, and the user accesses that unidentified hotspot (e.g., a private hotspot), the user may be prompted with an inquiry (e.g., via a display of the user interface 208) that elicits whether the user would like to add the network and its location to the database 206.

The timer component 210 generally operates to provide timing information to the network controller 202 responsive to particular events and prompts received from the network controller 202. In one mode of operation for example, the timer 210 provides an indication of how long the mobile device 200 has been outside of a coverage area of one or more of the wireless networks, and the network controller 202 uses this information to determine when to identify the location of the mobile device 200 in relation to locations of networks.

For example, if a connection with a wireless network is lost, the network controller 202 prompts the timer 210 to begin timing how long the mobile device 200 has been disconnected from the network, and before accessing the database 206, the network controller 202 continues, during a search-period, to search for the wireless network using the network interface that corresponds to the wireless network that the mobile device 200 is searching for. And after the search-period has ended, the network controller 202 then accesses the database 206 and receives device-location information from the GPS receiver 204. In this way, the mobile device 200 will not unnecessarily engage the GPS receiver 204 during a transient loss of network coverage.

The timer 210 may also be used to enable the network controller 202 to periodically actuate the GPS receiver 204 to obtain updated device-location information when the mobile device 200 is positioned in a location that is outside of any wireless network. In addition, the network controller 202 may utilize the timer 210 to wait for a period of time before enabling a particular network interface based upon the mobility of the mobile device 200.

The mobility calculator 212 generally provides an indication of movement of the mobile device 200 based upon the device-location information that is received from the GPS receiver 204. In many modes of operation for example, the mobility calculator 212 calculates and provides a velocity and direction of the mobile device 200 to the network controller 202 so that the network controller 202 may determine, based upon the network-location information retrieved from the database 206, when the mobile device 200 will be in a location that is covered by a wireless network. In addition, the network controller 202 may also determine the number and types of wireless networks that will become available and the anticipated time before the mobile device 200 enters the locations covered by the wireless networks.

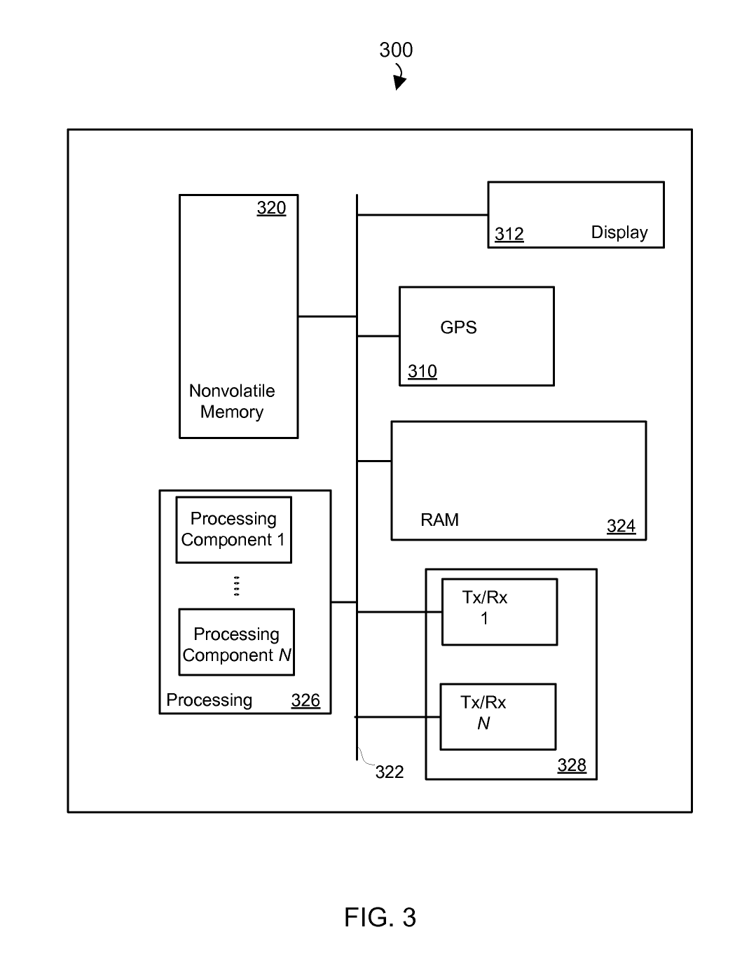

Referring next to FIG. 3, shown is a block diagram of a mobile device 300 depicting physical components of an exemplary embodiment of the mobile devices 100, 200 described with reference to FIGS. 1 and 2. As shown, the mobile device 300 in this embodiment includes a GPS component 310, a display portion 312, and nonvolatile memory 320 that are coupled to a bus 322 that is also coupled to random access memory (“RAM”) 324, a processing portion (which includes N processing components) 326, and a transceiver component 328 that includes N transceivers. Although the components depicted in FIG. 3 represent physical components of a mobile device (e.g., mobile device 100, 200) it is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

In general, the nonvolatile memory 320 functions to store (e.g., persistently store) data and executable code including code that is associated with the functional components depicted in FIG. 2. In some embodiments for example, the nonvolatile memory 320 includes bootloader code, modem software, operating system code, file system code, and code to facilitate the implementation of one or more portions of the network controller 202, user interface 208, the timer 210, mobility calculator 212, and the network interface 214.

In many implementations, the nonvolatile memory 320 is realized by flash memory (e.g., NAND or ONENAND™ memory), but it is certainly contemplated that other memory types may be utilized as well. Although it may be possible to execute the code from the nonvolatile memory 320, the executable code in the nonvolatile memory 320 is typically loaded into RAM 324 and executed by one or more of the N processing components in the processing portion 326.

The N processing components 326 in connection with RAM 324 generally operate to execute the instructions stored in nonvolatile memory 320 to effectuate the functional components depicted in FIG. 3. As one of ordinarily skill in the art will appreciate, the processing components 326 may include a video processor, modem processor, DSP, graphics processing unit (GPU), and other processing components.

The depicted transceiver component 328 includes N transceiver chains, which may be used in connection with realizing the network interface 214, for communicating with external devices via wireless networks (e.g., wireless networks 102, 104, 106). Each of the N transceiver chains represents a transceiver associated with a particular communication scheme. For example, one transceiver chain may operate according to WiFi communication protocols (e.g., 802.11 protocols), another may communicate according to 3G cellular protocols (e.g., CDMA or GSM protocols), and yet another may operate according to 4G protocols (e.g., CDMA or GSM protocols). Although the N transceivers are depicted as a transceiver component 328 for simplicity, it is certainly contemplated that the transceiver chains may be separately disposed about the mobile device 300.

This display 312 generally operates to provide visual images to a user including images that may include portions of the user interface 208. Although not depicted for clarity, one of ordinary skill in the art will appreciate that other components including a display driver and backlighting (depending upon the technology of the display) are also associated with the display 312.

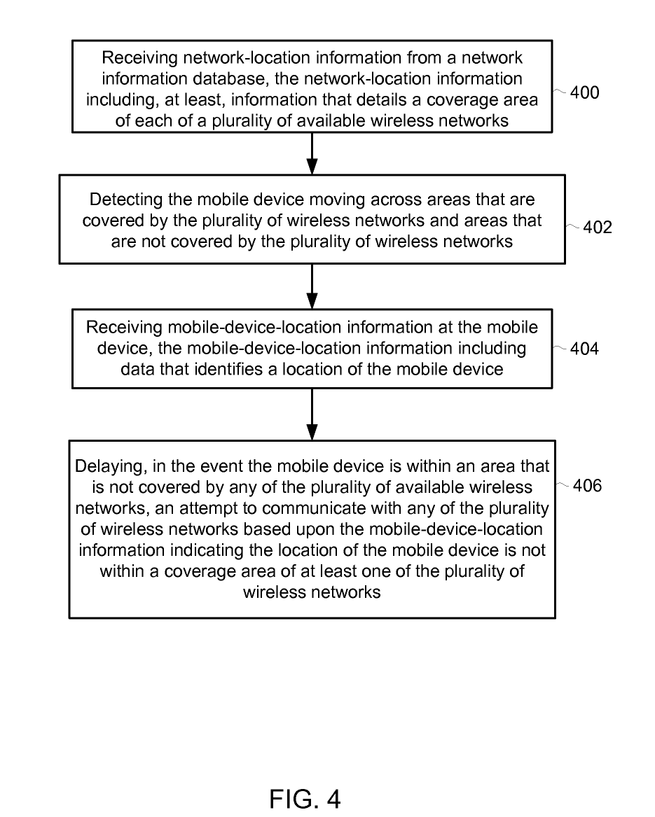

Referring next to FIG. 4, it is a flowchart that depicts a method that may be carried out in connection with the embodiments described with reference to FIGS. 1-3. As depicted, network-location information from a network information database is received that includes information that details a coverage area of each of a plurality of available wireless networks (Block 400).

As discussed above, when a mobile device (e.g., mobile device 100, 200, 300) is outside of the coverage area of a wireless network (e.g., wireless networks 102, 104, 106), the network-location information is retrieved from a database (e.g., database 206) on the mobile device, but while the mobile device is in a location with network connectivity, the network-location information may be updated with network-location information retrieved from a remote database (e.g., database 216) to reflect any changes (e.g., new or defunct networks) in the network-location information. In addition, the network-location information that is retrieved from the remote database may be tailored to an existing location of the mobile device, a location-history of the mobile device, specific user request, and/or a travel plan entered into the mobile device.

As shown in FIG. 4, movement of the mobile device across areas that are covered by the plurality of wireless networks and areas that are not covered by the plurality of wireless networks is detected (Block 402). In some modes of operation, if the mobile device loses a connection with a wireless network, after waiting for a predetermined search-period during which the mobile device attempts to connect with a network, the location of the mobile device is automatically detected (e.g., using the GPS receiver 204, 310) by default.

In other modes of operation, the user may simply be prompted with an option (e.g., by a message on a display of the mobile device) to engage the GPS receiver. In addition, it is contemplated that a user may set many parameters and conditions associated with the operation of the GPS receiver to reduce potential power usage including, for example, a period of intermittent use of the GPS receiver. In yet other modes of operation, the mobile device does not utilize a GPS receiver to detect movement of the mobile device unless the user has initiated travel in connection with an entered travel plan.

While the position of the mobile device is detected, the mobile device receives mobile-device-location information that identifies a location of the mobile device (e.g., a latitude and longitude of the mobile device)(Block 404), and if the mobile-device-location information indicates that the mobile device is not covered by any of the wireless networks, then attempts to communicate with a wireless network are delayed (Block 406).

As discussed previously, although not required, a velocity and direction of the mobile-device may be calculated (e.g., by the mobility calculator 212) so as to determine an anticipated time that the mobile device will once again be within a coverage area of one of the wireless networks, and attempts to communicate with the wireless network are delayed until that anticipated time (when the device is calculated to be within the wireless network) has lapsed.

In conclusion, embodiments of the present invention enable a mobile device to more effectively manage operating power based upon a relative location of the mobile device to wireless networks. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing network communications on a mobile device, the method comprising:
receiving network-location information from a network information database, the network-location information including, at least, information that details a coverage area of each of a plurality of available wireless networks;
determining mobile-device-location information at the mobile device, the mobile-device-location information based upon data received from a positioning system; and
delaying, in the event the mobile device is within an area that is not covered by any of the plurality of available wireless networks, an attempt to communicate with any of the plurality of wireless networks based upon the mobile-device-location information indicating the location of the mobile device is not within a coverage area of at least one of the plurality of wireless networks.

2. The method of claim 1, including:
receiving at least a portion of the network-location information from a remote network information database.

3. The method of claim 1, wherein receiving network-location information includes receiving network-type information for each of the plurality of available wireless networks.

4. The method of claim 3, including disabling network interfaces on the mobile device that are associated with network types that do not have coverage over the location of the mobile device.

5. The method of claim 1, including:
searching for signals of available wireless networks for a search-period in the event the mobile device loses communication with any of the available wireless networks, the search-period being an amount of time the mobile device searches for the signals using a wireless receiver before determining whether the mobile device is within a coverage area of the available wireless networks; and
determining, after the search-period has lapsed, whether the mobile-device-location information indicates the location of the mobile device is within a coverage area of at least one of the plurality of wireless networks.

6. The method of claim 5, including:
receiving a route-plan from a user of the mobile device that includes details of a planned route across the areas that are covered by the plurality of wireless networks and the areas that are not covered by the plurality of wireless networks;
identifying, using the network-location-information, the areas of the planned route that are not covered by the plurality of wireless networks; and
adjusting the search-period so that the amount of time the mobile device searches for the signals is lower based upon the planned route.

7. The method of claim 5, wherein receiving the mobile-device-location information at the mobile device includes receiving the mobile-device-location information from a GPS satellite after the search-period has ended.

8. The method of claim 7 including:
calculating, based upon the received mobile-device-location information, a direction and velocity of the mobile device so as to determine when the mobile device will be in an area that this is covered by at least one of the plurality of wireless networks; and
initiating the attempt to communicate with any of the plurality of wireless networks based upon the determination that the mobile device is in the area that is covered by the at least one of the plurality of wireless networks.

9. A mobile communication device comprising:
a GPS system that is configured to provide device-location information that identifies a location of the mobile communication device using GPS signals received from GPS satellites;
a data store configured to store network-location information including, at least, information that details a coverage area of each of a plurality of available wireless networks;
a wireless network interface configured to wirelessly communicate with at least some of the plurality of wireless networks; and
a network control system that is configured to enable and disable searches for wireless networks utilizing the wireless network interface based upon the device-location information in connection with that network-location information.

10. The mobile communication device of claim 9, including:
a plurality of network interfaces;
wherein the data store is configured to store network-location information that includes network-type information for each of the plurality of available wireless networks;
and wherein the network control system is configured to control whether each of the network interfaces is enabled or disabled based upon whether the network type corresponding to each network interface has coverage over the location of the mobile device.

11. The mobile communication device of claim 9, wherein the network control system is configured, in the event the mobile device loses communication with any of the available wireless networks to continue to search for a wireless network for a search-period before utilizing the device-location information and network-location information.

12. The mobile communication device of claim 11, wherein the GPS system is disabled until search-period has lapsed.

13. The mobile communication device of claim 9, wherein the network control system is configured to receive a route-plan from a user so as to enable the network control system to anticipate when the mobile device will be in areas that are not covered by one or more wireless networks.

14. The mobile communication device of claim 9, including:
a mobility calculator configured to calculate, based upon the received device-location information, a direction and velocity of the mobile device so as to determine when the mobile device will be in an area that this is covered by at least one of the plurality of wireless networks.

15. The mobile communication device of claim 9 wherein the data store is configured to store selected network-location information retrieved from a remote data base.

16. A mobile communication device comprising:
means for receiving network-location information from a network information database, the network-location information including, at least, information that details a coverage area of each of a plurality of available wireless networks;
means for receiving mobile-device-location information at the mobile device while the mobile device is moving across areas that are covered by the plurality of wireless networks and areas that are not covered by the plurality of wireless networks, the mobile-device-location information including data that identifies a location of the mobile device;
means for delaying, in the event the mobile device is within an area that is not covered by any of the plurality of available wireless networks, an attempt to communicate with any of the plurality of wireless networks based upon the mobile-device-location information indicating the location of the mobile device is not within a coverage area of at least one of the plurality of wireless networks.

17. The mobile communication device of claim 16, wherein the means for receiving network-location information includes means for receiving network-type information for each of the plurality of available wireless networks.

18. The mobile communication device of claim 17, including means for disabling network interfaces on the mobile device that are associated with network types that do not have coverage over the location of the mobile device.

19. The mobile communication device of claim 16, including:
means for searching for signals of available wireless networks for a search-period in the event the mobile device loses communication with any of the available wireless networks, the search-period being an amount of time the mobile device searches for the signals using a wireless receiver before determining whether the mobile device is within a coverage area of the available wireless networks; and
means for determining, after the search-period has lapsed, whether the mobile-device-location information indicates the location of the mobile device is within a coverage area of at least one of the plurality of wireless networks.

20. The mobile communication device of claim 19, including:
means for receiving a route-plan from a user of the mobile device that includes details of a planned route across the areas that are covered by the plurality of wireless networks and the areas that are not covered by the plurality of wireless networks;
means for identifying, using the network-location-information, the areas of the planned route that are not covered by the plurality of wireless networks; and
means for adjusting the search-period so that the amount of time the mobile device searches for the signals is lower based upon the planned route.

21. The mobile communication device of claim 19, wherein the means for receiving the mobile-device-location information at the mobile device includes means for receiving the mobile-device-location information from a GPS satellite after the search-period has ended.

22. The mobile communication device of claim 21 including:
means for calculating, based upon the received mobile-device-location information, a direction and velocity of the mobile device so as to determine when the mobile device will be in an area that this is covered by at least one of the plurality of wireless networks; and
means for initiating the attempt to communicate with any of the plurality of wireless networks based upon the determination that the mobile device is in the area that is covered by the at least one of the plurality of wireless networks.

23. A non-transitory, tangible computer readable storage medium, encoded with processor readable instructions to perform a method for managing power on a mobile device, the method comprising:
receiving network-location information from a network information database, the network-location information including, at least, information that details a coverage area of each of a plurality of available wireless networks;
receiving mobile-device-location information at the mobile device while the mobile device is moving across areas that are covered by the plurality of wireless networks and areas that are not covered by the plurality of wireless networks, the mobile-device-location information including data that identifies a location of the mobile device; and
delaying, in the event the mobile device is within an area that is not covered by any of the plurality of available wireless networks, an attempt to communicate with any of the plurality of wireless networks based upon the mobile-device-location information indicating the location of the mobile device is not within a coverage area of at least one of the plurality of wireless networks.

24. The non-transitory, tangible computer readable storage medium of claim 23, wherein receiving network-location information includes receiving network-type information for each of the plurality of available wireless networks.

25. The non-transitory, tangible computer readable storage medium of claim 24, wherein the method includes:
disabling network interfaces on the mobile device that are associated with network types that do not have coverage over the location of the mobile device.

26. The non-transitory, tangible computer readable storage medium of claim 23, wherein the method includes:
searching for signals of available wireless networks for a search-period in the event the mobile device loses communication with any of the available wireless networks, the search-period being an amount of time the mobile device searches for the signals using a wireless receiver before determining whether the mobile device is within a coverage area of the available wireless networks; and
determining, after the search-period has lapsed, whether the mobile-device-location information indicates the location of the mobile device is within a coverage area of at least one of the plurality of wireless networks.

27. The non-transitory, tangible computer readable storage medium of claim 26, the method including:
receiving a route-plan from a user of the mobile device that includes details of a planned route across the areas that are covered by the plurality of wireless networks and the areas that are not covered by the plurality of wireless networks;
identifying, using the network-location-information, the areas of the planned route that are not covered by the plurality of wireless networks; and
adjusting the search-period so that the amount of time the mobile device searches for the signals is lower based upon the planned route.

28. The non-transitory, tangible computer readable storage medium of claim of claim 27, wherein receiving the mobile-device-location information at the mobile device includes receiving the mobile-device-location information from a GPS satellite after the search-period has ended.

29. The non-transitory, tangible computer readable storage medium of claim 28 including:
calculating, based upon the received mobile-device-location information, a direction and velocity of the mobile device so as to determine when the mobile device will be in an area that this is covered by at least one of the plurality of wireless networks; and
initiating the attempt to communicate with any of the plurality of wireless networks based upon the determination that the mobile device is in the area that is covered by the at least one of the plurality of wireless networks.
